(19) United States
(12) Patent Application Publication
(10) Pub. No.: US 2023/0083846 A1
(43) Pub. Date: Mar. 16, 2023

(54) ARTIFICIAL INTELLIGENCE DECISION MODELING PROCESSES USING ANALYTICS AND DATA SHAPELY FOR MULTIPLE STAKEHOLDERS

(71) Applicants: Michael William Kotarinos, Palm Harbor, FL (US); Christos Tsokos, Tampa, FL (US)

(72) Inventors: Michael William Kotarinos, Palm Harbor, FL (US); Christos Tsokos, Tampa, FL (US)

(21) Appl. No.: 17/978,347

(22) Filed: Nov. 1, 2022

Related U.S. Application Data
(63) Continuation of application No. 16/703,145, filed on Dec. 4, 2019.

(51) Int. Cl. G06Q 40/06; G06N 20/00; G06N 5/04; G06Q 40/04

(52) U.S. Cl. CPC G06Q 40/06; G06N 20/00; G06N 5/045; G06Q 40/04

(57) ABSTRACT

Data Shapley is an approach to understand the role of data in a decision-making process. The present invention involves a process to connect Data Shapley to a data analytics and machine learning based decision-making environment through the use of utility functions. In the present invention a problem is structurally analyzed using machine learning and data analytics to determine structural trends. Data is then analyzed using Data Shapley to determine what additional information is needed to make a decision. This allows for the relevant data to be collected to estimate utility functions for participants. Data Shapley is then used again to decompose the decision-making process and look for trends in the process, and machine learning is applied to see if there are commonalities across the criteria in the decision-making process. After this, the decision-making process selects a strategy as the decision. If new information becomes available or an event occurs that makes a change of strategy necessary, then Data Shapley is used to guide the data acquisition and decision-making process. If no new information is available or an event does not occur, event occurrence is dynamically predicted using data analytics and Data Shapley proactively recommends what data streams to monitor and collect.

### FIELD OF THE INVENTION

The present invention relates generally to methods to develop a decision-making model and more specifically to the use of artificial intelligence and Data Shapley to develop decision making models to develop structural trends utilizing one or more factors.

### BACKGROUND OF THE INVENTION

With the advent of cloud computing, large data centers and advances in machine learning and artificial intelligence one of the biggest issues' society must grapple with is the treatment of data. Analytical methods, algorithms and techniques to analyze, sort and characterize patterns in data have developed faster than regulations and rules to govern data collection and usage. Firms must deal with a patchwork of regulations that differ by country and region and are sometimes unclear and inconsistent with regards to new statistical innovations.

Some of the innovations forming the basis for the prior art of this new innovation predate the big data revolution. The Shapley value represents a game theoretic model that discusses how a group of players should distribute the gains from a new innovation (Dubey, 1975). Data Shapley represents a parallel to this idea where instead of a new manufacturing method or trade route one may instead consider new data acquired. Consider a new observation in a study. This new sample point increases the amount of information available and has value, leading to more accurate estimation. As more relevant information is acquired, statistical models become more powerful and can provide estimates with a greater degree of accuracy, and as such there is an incentive to acquire additional data in many circumstances. This is because as we acquire more data, we come closer to understanding the unknown phenomenon driving the process in question. The individual supplying this data must have incentive to provide it, so value must be generated for him or her.

For example, an individual participating in a medical trial receives a new treatment (an experimental treatment). In exchange for receiving access to a new experimental procedure the participant consents for his or her data to be used to assess the effectiveness of the new treatment. In another example, a company allows access to customized and highly accurate search results in exchange for learning more about an individual, allowing for more targeted advertising. Now, Consider a market with multiple participants. For example, there are multiple companies such as Tencent and Facebook that offer services that connect users with each other and allow for communication, sharing of ideas and the building of social networks. These services must compete against each other to continue adding value to the user in exchange for his or her data. These companies must also compete in different regulatory environments and must meet the needs of investors who also have a set of investment objectives that must be fulfilled. These factors all add to the complexity of understanding the role and purpose of additional data being generated.

Some data points in a study can have a bigger impact than other data points and lead to different insights. In the clinical trial example, an individual suffering from a rare disease or unusual health condition represents a more valuable data point than a healthy individual with no health complications. The data obtained from the person with a rare disease provides numerous data points that can be measured from issues specific to that disease. In the example of a social network, some individuals have a higher propensity to spend money on a social network, for example making in-application purchases on games. Keeping these individuals engaged with a network and understanding their characteristics represents a more valuable data point than a user with a limited amount of engagement. Furthermore, the value of these data points can change. In the example of a social network, an individual may be a candidate to spend money on a game product, but the right product to have this user change from a free user to a premium user has not yet been developed. This represents the potential value for a data point that has not yet been realized. One of the new proposed approaches to solve this problem involves using Data Shapley to calculate the Shapley value for a data point, which is known to have some desirable theoretical properties (Data Shapley: Equitable Valuation of Data for Machine Learning, Amirata Ghorbani, James Zou). These results and the desirability are based on the game theoretic background of the Shapley value that allows for a connection from an old problem to existing literature. However, the Shapley value alone is not enough. Consider again our example of a member of a social network which has the potential to spend on in-app purchases but has not done so as of yet. This individual's value may appear quite low, but the fact that there is a chance the individual could transition from a free user to a premium user should not be ignored.

There are multiple ways that data can be interpreted and scored, with factors that can be intrinsic (how relevant and unique the data) and extrinsic (based on market conditions). The analysis and interpretation of these factors in a Data Shapley environment must be ontextualized, as in our example (Raskar, Ramesh, et al. “Data Markets to support AI for All: Pricing, Valuation and Governance.” arXiv preprint arXi:1905.06462 (2019)). Often, individuals will need to make decisions with multiple criteria to solve complex problems. One approach to this process is determining the most important criteria, figuring out how to weight these criteria and then using these weights to make a decision and check the robustness of this decision to evaluate the individual's objectives. These ideas form the basis of a technique known as Multi-Criteria Decision Analysis (MCDA) (Marttunen, Mika, Judit Lienert, and Valerie Belton. “Structuring problems for Multi-Criteria Decision Analysis in practice: A literature review of method combinations.” European Journal of Operaronal Research 263.1 (2017): 1-17).

While MCDA is a powerful tool, one of the issues becomes in determining what criteria to use in the selection process. While there is also some discussion about robustness, there is not a technique that is commonly used to deconstruct the entire process and see the larger role that different pieces of information play. The Shapley score from game theory provides an interesting approach but connecting this value into a larger MCDA framework is a non-trivial process and does not have a straightforward implementation. This invention represents a significant contribution by providing a framework for making decisions in this environment. The authors are not aware of another cohesive approach in the prior art.

One issue is performing analysis with and decision making with multiple decision makers and or stakeholders. This forms the basis of decision conferencing, which involves collating the decisions of all these participants (Baudry, Gino, Cathy Macharls, and Thomas Vallee. “Range-based Multi-Actor Multi-Criteria Analysis: A combined method of Multi-Actor Multi-Criteria Analysis and Monte Carlo simulation to support participatory decision making under uncertainty.” European Journal of Operational Research 264.1 (2018): 257-269.) Sometimes preferences for multiple stakeholders can be difficult to compress and represent, and as such it can be difficult in practice to apply quantitative tools that should work in theory due to disagreements and difficulties across stakeholders. Even the use of traditional Monte Carlo simulation is limited to low dimensional problems, as high dimensional investigations of state spaces are dependent on Markov Chain Monte Carlo and other specialized search processes and the assumptions underlying the usage of Monte Carlo methods are often violated. This is a contrast to game theory approaches, which instead focus on developing theoretical models for the preferences of participants. Game Theory and Decision Conferencing both try to understand the preferences and beliefs of participants, but tend to differ in application as game theorists use theoretical models and mathematical tools while decision conference applicants tend to use theories from consulting and psychology. Both offer interesting ideas, and ideas that combine and mix these approaches such as Shapley values for utility construction and also MCDA techniques to build a larger skeleton of a framework represent an evolution from the literature in both of these fields. The present inventions solve the problem specified above.

One of the foundations of the MCDA and other existing approaches are those of rational participants. This involves making some assumptions on the nature of a preference, such as transitivity (if an individual prefers A to B and B to C, then by transitivity he or she prefers A to C). However, people often have complex and nuanced beliefs and when aggregating multiple preferences and users together these rationality assumptions do not always hold. While some work continues to be done on non-rational preferences (He, Wei, and Nicholas C. Yannelis. “Existence of Walrasian equilibria with discontinuous, non-ordered, interdependent and price-dependent preferences.” Economic Theory 61.3 (2016): 497-513.) there is not an exhaustive body of work that suggests how one could actually implement this theoretical work into a workable framework. Even then, the amount of theoretical work being done in this area is quite limited, as economists are not in universal agreement on whether beliefs are irrational or if the models are simply improperly specified. There is limited work in the prior art focusing on irrational beliefs from an economics and data-based perspective, as most of the work on irrational and inconsistent beliefs is done by psychologists and is not as econometrically rigorous. Significant developments such as those in the proposed invention tend to be difficult to reach not only because of analytical complexity but because so little work tends to be done in this area. Some previous patents have done some work regarding product development and Shapley notions. U.S. Pat. No. 10,395,272 focused on developing a game theoretic approach to understanding how different marketing channels affect user behavior and using these to determine the best ways to develop and promote new products. This is quite a bit different than the proposed invention as U.S. Pat. No. 10,395,272 focuses on product promotion and development, rather than understanding an individual's inherent desires and needs. Furthermore, the objective of U.S. Pat. No. 10,395,272 is focused on the role of an external stimulus on the change in desires, rather than the existing preferences before the exposure to marketing.

There has also been some use of Shapley values to assess network quality in U.S. Pat. No. 10,285,080. The '080 patent is focused on the application to cellular towers and the roles of cell towers in understanding overall network performance, rather than a focus on the role of Shapley in the formulation of the Data Shapley estimator and the modeling of complex preference structures. As such, the '080 patent did not address analyzing sensitivity and robustness of Shapley procedures. In the proposed invention the analytical modeling and structure of preferences may not be straightforward, and the metric may not always be clear or even related to a metric space. There are also similar applications to electrical grids in U.S. Pat. No. 10,284,011. The pricing of electrical grids using auction theory based on theoretical Shapley values is shown in U.S. Pat. No. 9,940,666. The '666 patent focuses on specific game theoretic applications that are generally not robust to variations in model assumptions. U.S. Pat. No. 10,284,011 attempts to answer some questions about robustness but is focused on the unique architecture and structure that tends to appear in cellular networks rather than on multiple user decision making with complex choices. All the prior art tends to focus on robustness of estimates to solve the problem rather than implementing a reconstruction of a decision-making process with artificial intelligence. The combination of artificial intelligence and multiple decision makers making complex choices represents a significant innovation in the proposed invention.

U.S. Pat. No. 9,311,670 focuses on an optimization system for auctions using game theory, which includes such methods as the Shapley approach. This is based on data revealed during an auction process, which tends to be different from the Data Shapley approach. Data Shapley emphasizes data obtained through data collectors (such as clinical trials), not a single snapshot revealed by auction bids. Auction theory leads to many beliefs regarding the structure of preferences based on bids during an auction preference if all the actors are rational, which forms the basis of Hoffberg's patent (Gomes, Renato, and Kane Sweeney. “Bayes-nash equilibria of the generalized second-price auction.” Games and economic behavior 86 (2014): 421-437.). These teachings contrast with the invention's approach of using real-time data from multiple data streams for a decomposition of the decision-making process, which can be quite sensitive. Similarly, U.S. Pat. No. 9,916,618 looks at an online auction system with multiple buyers or sellers, where offers may fall through. The '618 patent has an e-commerce focus on connecting buyers to sellers and facilitating reliable online multi-participant auction systems, similar to those seen on Ebay's platform. This is different in scope than the current inventions, which analyze and collect the beliefs of multiple stakeholders (rather than one buyer and one seller), and does not necessitate an auction system where an asset is transferred from one participant to another (for example, a clinical trial is not an “auction” of compounds but instead an investigation and search for information). There are many other similar patents involving online auction systems such as U.S. Pat. Nos. 9,886,719; 8,600,830; and 8,355,978. Many of the prior art patents focus on applications of game theory techniques such as Shapley to auction theory, as auctions have always been a fertile ground for applications of game theoretic results due to the relationship between participants and the tendency for auction bids to reveal information about user preferences. These techniques tend to be different in scope, application, and approach from our proposed invention which is not focused on auctions and or online platforms but on broader ideas regarding the nature of real data and what observational real data, not auction bids, reveals about optimal decisions. The process of making decisions based on real data and reaching conclusions that are statistically sound, consistent with economic theory, and allow for irrational and inconsistent beliefs is a significant innovation in the proposed invention.

The proposed inventions use insights from multiple fields such as decision theory, data analytics, machine learning and electrical engineering to reach new insights into this problem. As such, the prior art does not to address the need of combining Data Shapley with MCDA approaches.

### SUMMARY OF THE INVENTION

Companies have become increasingly reliant on technology to make decisions and automatically adjust to market changes in real-time. While the Shapley approach to collective bargaining has existed since the 1950s, it represented in its inception a way of modeling theoretical interactions in an environment with sparse data.

Markets have evolved, and the integration of data with theory for real-time adjustments is a critical revolution in data analytics. The Data Shapley approach extends the ideas behind Shapley to a data rich environment. However, this extension lacks the theoretical foundations and direct ties to utility functions of the original implementation.

One of the objectives of the present inventions involves extending Data Shapley to a decision-making environment that can automatically adjust and reinvent itself in real-time. This connection of Data Shapley to a Data Shapley utility decision environment is synonymous to the connection of Shapley to Data Shapley.

The end result being able to automatically adjust and reinvent the application in real time develops a new process that blends theory and data together to make decisions that are multi-faceted. These are not binary choices, but rather strategy profiles that are structured to change and adapt in real time as markets evolve. As new data becomes available, these decisions shift. As such, the new functions resemble less of the traditional decisions that Shapley and Data Shapley produce and instead resemble strategy profiles produced by consultants without analytical justification. These functions are usable both individual users and for multi-user environments, such as trusts and institutions.

The proposed invention is a multi-stage process for a complete decomposition and restructuring of a decision making process that involves using decision theory, game theory, and data Shapley to create a framework for making real-time decisions in an individual or group environment and adjusting their decisions in real-time for the arrival of new information. The preferred steps of the current inventions and the objects of the present inventions include a computer system that drives the analytical process, including one or more of the following steps:
1. Determining the problem to be investigated and establishing decision making factors.
2. Using data analytics and machine learning to analyze the structure of the problem and determining any possible factors or use decision conferencing techniques to arrive at a consensus of factors for the stakeholders.
3. Centralizing and converting into compatibly scaled and stored quantitative data the information currently available.
4. Using Data Shapley to determine the most valuable new information to acquire in the decision-making process.
5. Estimating a group of utility functions for all the participants using decision theory and assessing the amount of variation and robustness in this utility estimate. Analyzing a trade-off between gathering additional information using Data Shapley guidance or proceeding with the current estimates.
6. Using Data Shapley to decompose the decision-making process and obtain estimates of the role each factor plays after a sufficiently accurate estimate has been generated. Using machine learning and data analytics to scour this structure for trends and important factors that play a role in contributing to the decision-making process.
7. Fashioning a decision based on the available information. Retaining the information relating to the trends and factors that play a role in the decision process.
8. Sensing a change in conditions and using the retained information relating to the trends and factors that play a role in the decision process. Understanding how these changes affect the overall process based on the Data Shapley decomposition. Dynamically and automatically determining if the change is important and determining if the change is important or if the change is important but more information is needed to make a decision:
   8.1 Choosing a strategy from one of the options.
   8.2 If the change is not important, retain the same decision.
   8.3 If the chance is important but we can still draw a conclusion based on the available information then reach a decision.
   8.4 If the change is important and the estimates are too volatile, use Data Shapley to guide the new data collection process. This will lead to a new decision.
9. Using data analytics if the conditions have not been changed to attempt to predict what may happen and where issues may arise in the decision-making process.
   Proactively collect data on these new events.

### BRIEF DESCRIPTION OF THE DRAWINGS

FIG. 1 is a step-by-step process flow diagram of one embodiment of the present invention depicting for the single stakeholder in a clinical trial setting.

FIG. 2 is a step-by-step process flow diagram of one embodiment of the present invention depicting for the single stakeholder in a clinical trial setting.

FIG. 3 is a step-by-step process flow diagram of one embodiment of the present invention depicting a Data Shapley process overview.

FIG. 4 is a step-by-step process flow diagram of one embodiment of the present invention depicting a decision decomposition overview.

FIG. 5 is a step-by-step process flow diagram of one embodiment of the present invention depicting multiple stakeholders in a clinical trial.

FIG. 6 is a step-by-step process flow diagram of one embodiment of the present invention depicting multiple stakeholders in a clinical trial.

FIG. 7 is a step-by-step process flow diagram of one embodiment of the present invention depicting multiple stakeholders in a trust.

FIG. 8 is a step-by-step process flow diagram of one embodiment of the present invention depicting multiple stakeholders in a trust.

### DETAILED DESCRIPTION OF THE PREFERRED EMBODIMENTS

Set forth below is a description of what is currently believed to be the preferred embodiments or the best representative examples of the inventions claimed. Future and present alternatives and modifications to the embodiments and preferred processes or methods are contemplated. Any alternatives or modifications which make insubstantial changes in function, purpose, steps, structure or results are intended to be covered by the claims of this patent.

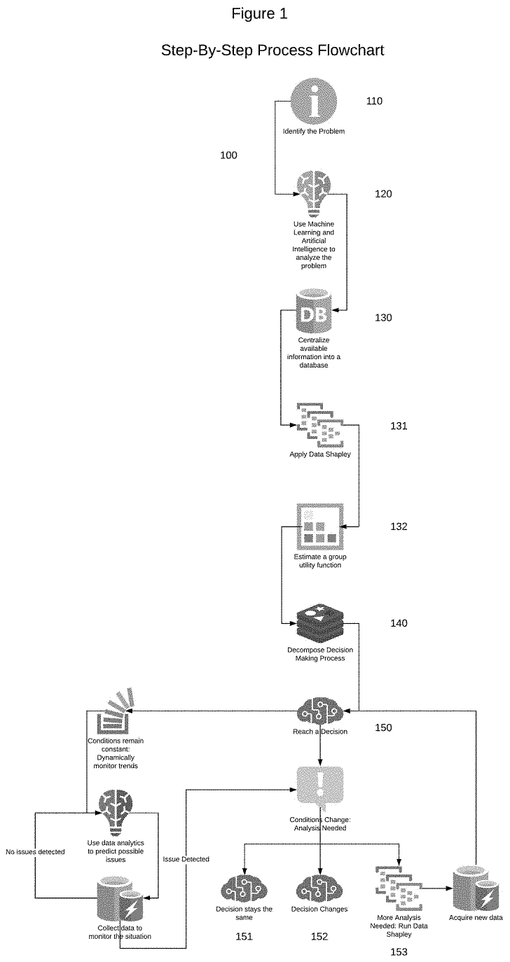

In FIG. 1, a step-by-step flowchart 100 of the process in the proposed invention is displayed. This process involves identifying the problem 110, using machine learning and artificial intelligence to analyze the problem to determine the most important factors 120, collating the available information into a database 130, using Data Shapley to determine what additional data to collect or a data collection variable 131, using Data Shapley and artificial intelligence to decompose the analytical structure of the problem 140, and then reaching a decision 151, 152 and 153. Once a decision is reached, the process adjusts the decision as new information becomes available. If no new information becomes available, the process proactively attempts to anticipate new trends using data analytics and actively seek out new information.

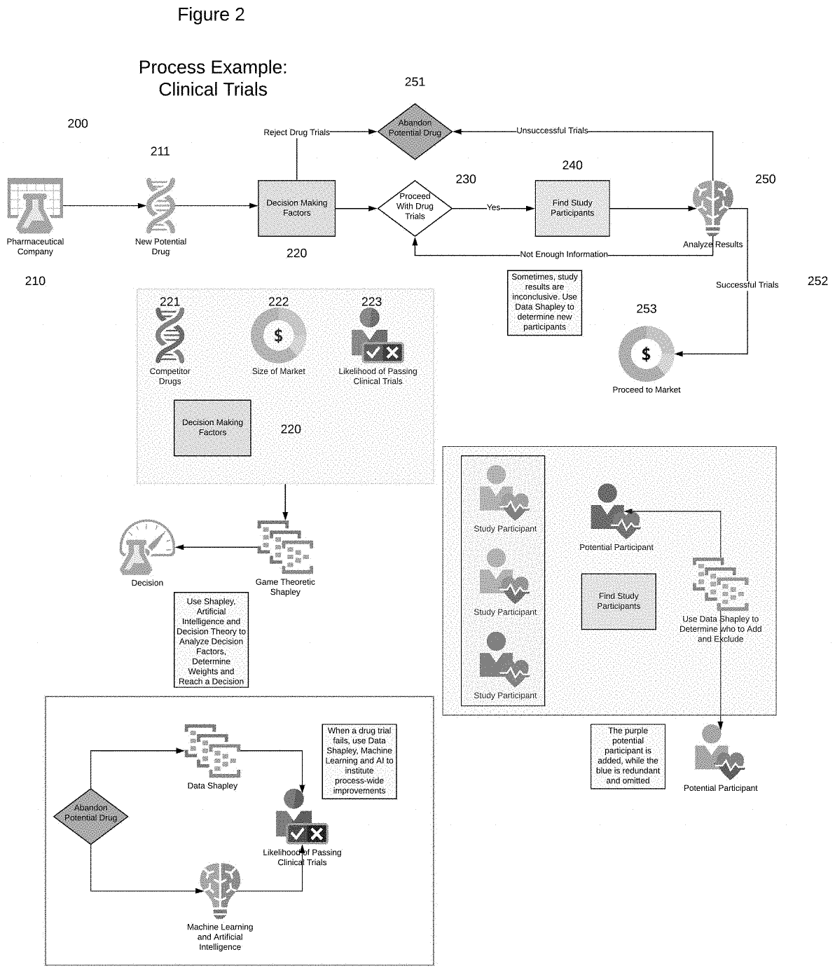

In FIG. 2, an example of the use of the proposed process for a clinical trial 200 is given. In this example, when the pharmaceutical company 210 is investigating a new compound or drug 211, the system makes a determination based on certain factors 220 including the presence of competitors in the market 221, the size of the market 222 and the likelihood of passing clinical trials 223. For example, if the company decides to proceed with a compound 230, they can use Data Shapley 240 to determine what study participants to use. The process uses Data Shapley if the results are inconclusive to determine what additional data is needed to inform what additional participants to recruit. This can lead to substantial cost savings, as using optimal study participants can lower the sample size requirement. It also allows the study to be done in stages, where if the initial results are not promising the trial can be abandoned early 250. If the drug trial is not a success 251, the analytical structure may be decomposed using Data Shapley combined with data analytics to try to determine what factors in the compound lead to the poor result. This can lead to new insights and a better estimate in the future of a compound's likelihood of passing clinical trials. If the clinical trials are successful 252 then after regulatory approval the compound can be launched as a drug in the market 235.

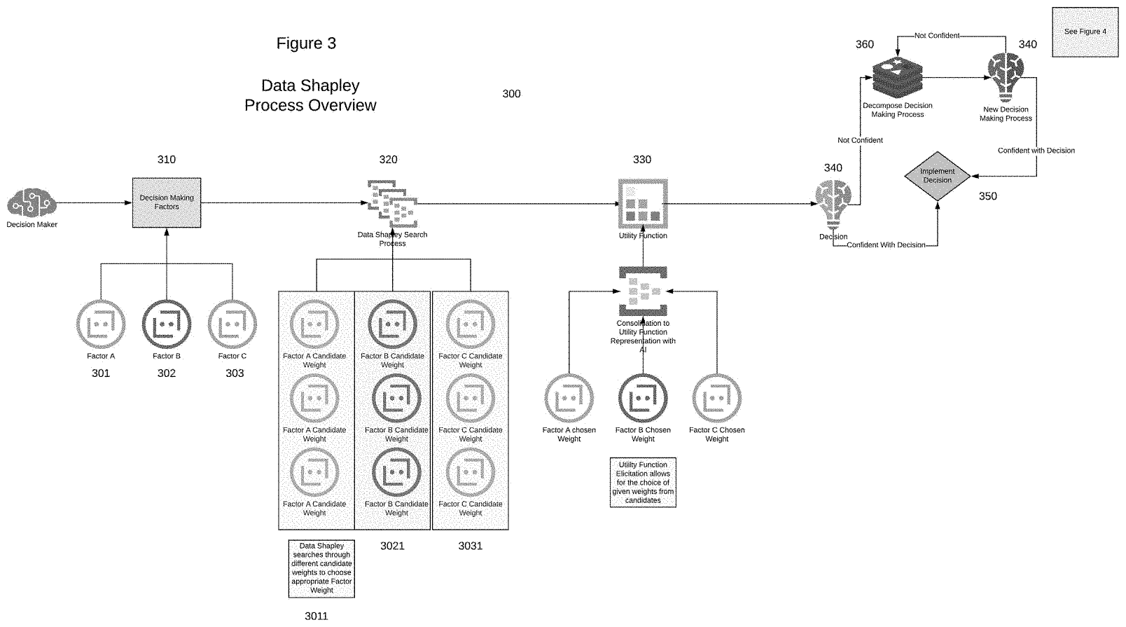

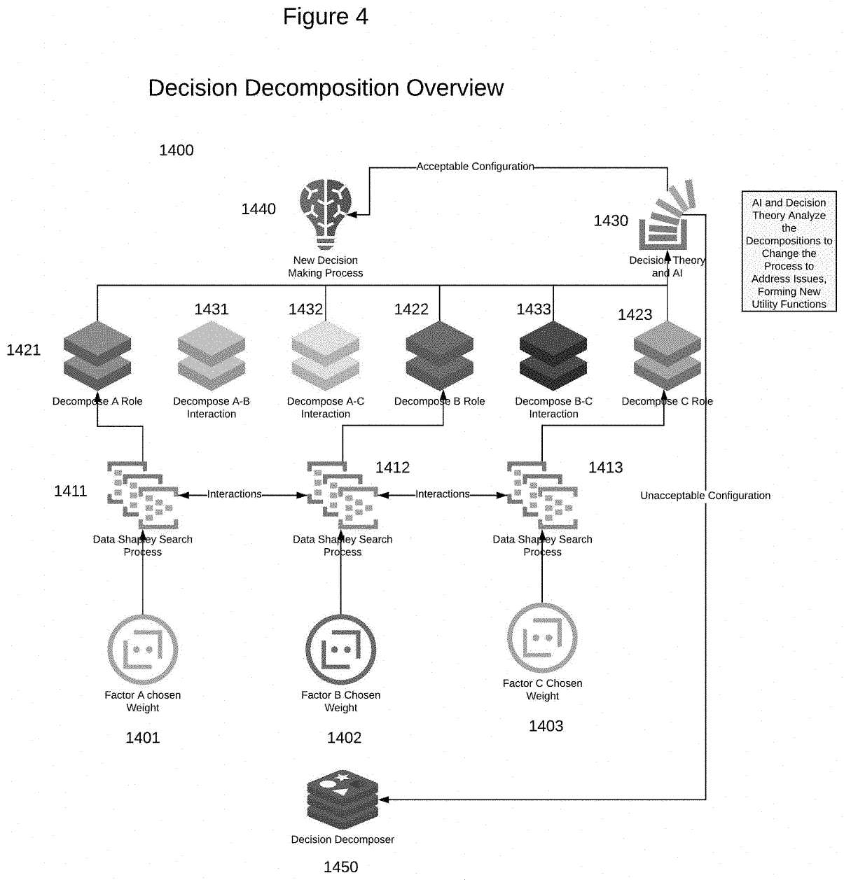

In FIG. 3 an overview of the Data Shapley weighting process 300 is shown. In this example, the decision-making factors must be determined 310. Here, there are three different factors: Factor A 301. Factor B 302 and Factor C 303. The Data Shapley process 320 analyzes relationships between these three factors 301, 302, 303 to determine the most appropriate weights for each 3011, 3021, 3031. This is done by searching through different factors given a weight until an appropriate weight is found. Once the given weights are established, then artificial intelligence and data analytics are used to consolidate this information in a utility function representation 330. A utility function is a rank ordering of preferences. A higher utility score means a more preferred option. For example, if there are two choices, 1 and 2, and 1 has a higher utility score than 2 then it means 1 is preferred to 2. This leads to a decision 340 which is implemented 350. If the stakeholders have questions about the decision-making process then the decision is decomposed 360 and a new decision can be reached 370, as can be seen in FIG. 4.

FIG. 4 shows a decision-making process being decomposed 1400. In this decomposition, the weights for Factors A 1401, B 1402 and C 1403 from FIG. 3 are fed into a Data Shapley search process 1411, 1412 and 1413 and analyzed with data analytics to look at interactions between the different factors. Interactions 1421, 1422, 1423 tend to be very important in many areas, especially clinical trials, so by looking at the interactions between decision-making factors 1431, 1432 and 1433 more accurate decisions can be reached. Once these interactions are understood the data is passed through an artificial intelligence system 1430 using decision theory to reach an updated decision 1440. This process can help decision makers who are unsure about the robustness of a decision critically evaluate the way the decision-making process is being made and how big of a role each factor played in the process, adding additional clarity to the analytical approach.

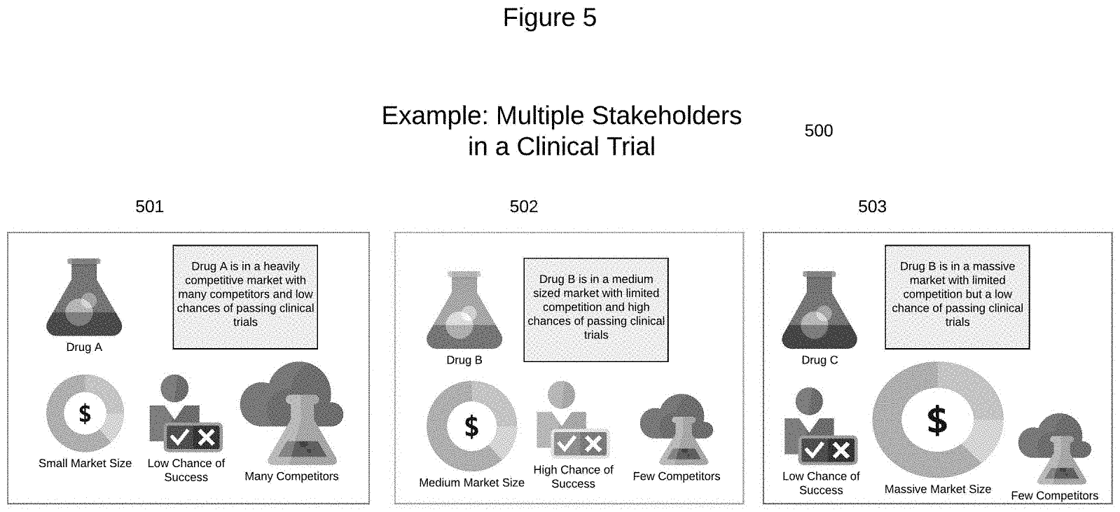

FIG. 5 shows an example of multiple stakeholders in a decision-making process 500. In this example, a pharmaceutical company is choosing between three drugs A 501, B 502 and C 503 to send to clinical trials and is looking to choose only one. Drug A 501 is in a heavily competitive market with a small market size, low chance of success, and many competitors. Drug B 502 is in a medium-sized market with a high chance of success and few competitors. Drug C 503 is in a massive market with few competitors but with a low chance of success.

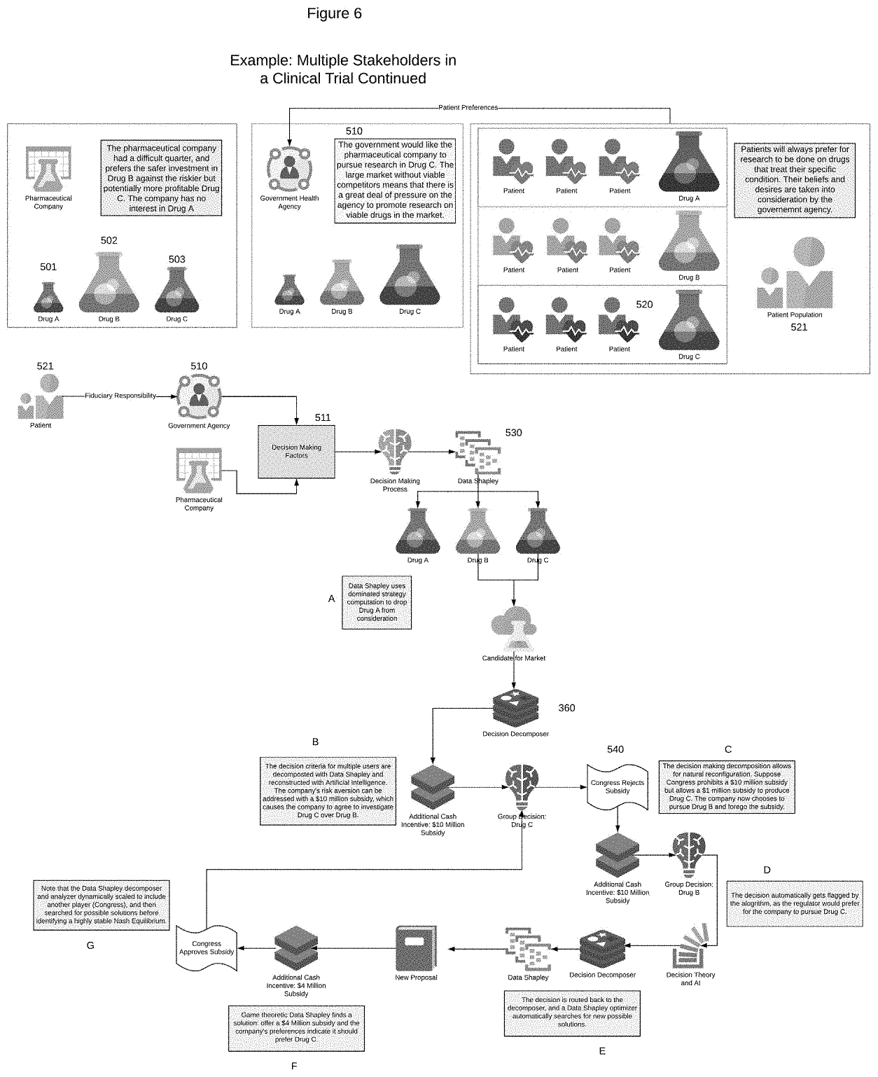

FIG. 6 shows how the different stakeholders approach the problem with the drugs from FIG. 5. None of the stakeholders (except for the patients who could benefit from drug A) prefer Drug A 501, as it is dominated by Drugs B 502 and C 503 which outperform on all criteria. The pharmaceutical company prefers the less risky Drug B 502. Meanwhile, the government regulator 510 prefers Drug C since they are under pressure to promote research on drugs in this sector. The potential patients 520 all prefer drugs that would be targeted to them 521. The views of the patients in these markets are expressed and managed by the regulatory agency 510 which has a duty to represent their interests. FIG. 6 shows the proposed Data Shapley decision heuristic (530) invention drops Drug A from consideration to make the decision process 511 more straightforward. Data Shapley uses dominated strategy computation to drop Drug A from consideration. The decision decomposer 360 then leads to a suggested compromise, suggesting a subsidy for the pharmaceutical company to pursue the riskier drug in a clinical trial. The decision criteria for multiple users are decomposed with Data Shapley and reconstructed with artificial intelligence. The company's risk aversion can be addressed with a $10 million subsidy, which causes the company to agree to investigate Drug C over Drug B. The decision-making decomposition allows for natural reconfiguration. Suppose Congress prohibits a $10 million subsidy but allows a SI million subsidy to produce Drug C. The company now chooses to pursue Drug B and forego the subsidy. The decision automatically gets flagged by the algorithm, as the regulator would prefer for the company to pursue Drug C. This addresses the risk aversion concern of the pharmaceutical company and allows the regulator to have another potential drug being researched in this larger market. If congress rejects this subsidy 540, the decision decomposer 360 can be used with data analytics and Data Shapley to search for other possible solutions and see if another compromise can be reached. The decision is routed back to the decomposer, and a Data Shapley optimizer automatically searches for new possible solutions. In this case, a smaller proposed subsidy is suggested which would lead to Drug C still being pursued. Game theoretic Data Shapley finds a solution: offer a $4 million subsidy and the company's preferences indicate it should prefer Drug C. Note that the Data Shapley decomposer and analyzer dynamically scaled to include another player (Congress), and then searched for possible solutions before identifying a highly stable Nash Equilibrium.

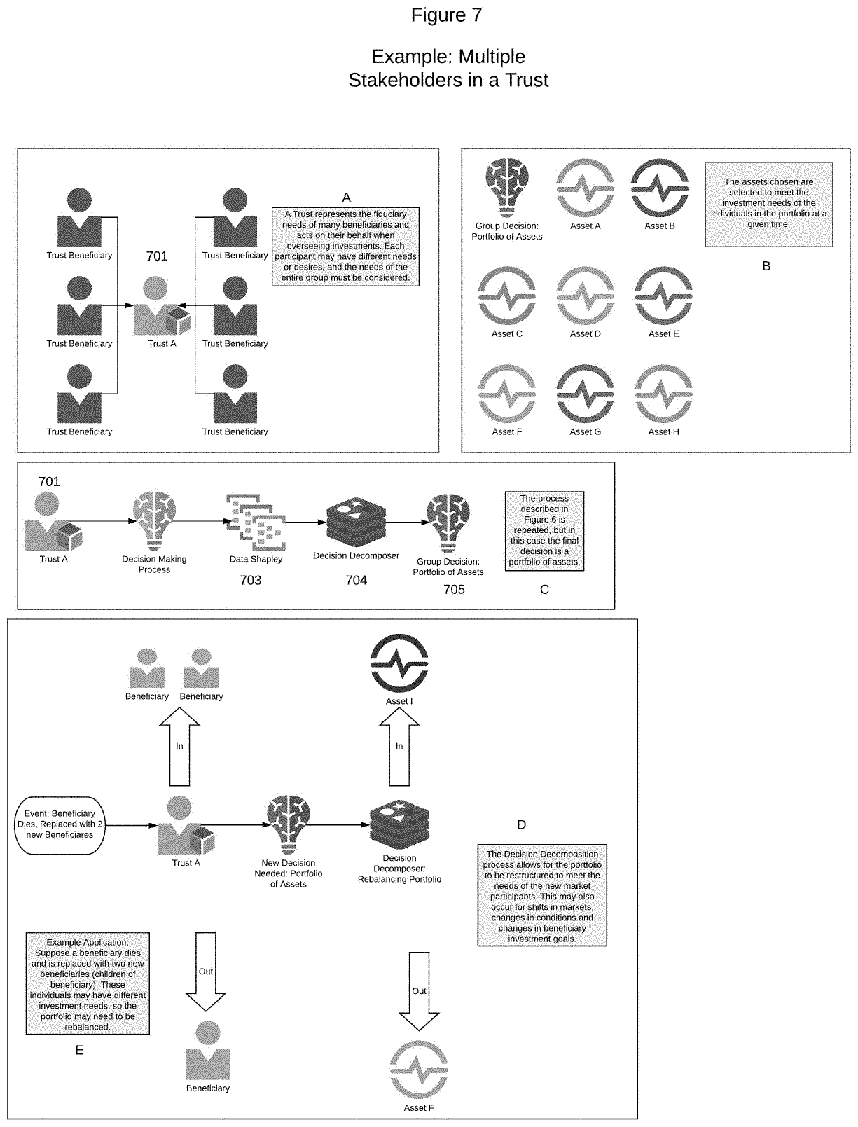

FIG. 7 shows an example of using an embodiment of proposed invention to manage the needs of multiple beneficiaries in a trust. In this example, the trust has six beneficiaries. A trust represents the fiduciary needs of many beneficiaries and acts on their behalf when overseeing investments. Each participant may have different needs or desires, and the needs of the entire group must be considered. The manager of the trust needs to choose a basket of assets to invest in to manage the funds of the trust based on the needs of each participant in the trust. The assets chosen are selected to meet the investment needs of the individuals in the portfolio at a given time. The trust manager 701 can use Data Shapley 703 and a decision decomposer 704 to make a decision 705 with multiple stakeholders, similar to the pharmaceutical example from FIG. 6. The process described in FIG. 6 is repeated, but in this case the final decision is a portfolio of assets. The proposed invention can dynamically adjust as new information becomes available or events happen, as seen in the flowchart in FIG. 1. In this example, suppose a beneficiary of the trust dies and is replaced by two new beneficiaries. A common real-life example of this is a parent who is the beneficiary of a trust passing away and his or her children becoming beneficiaries of the trust. This means that the trust may need to rebalance some assets. For example, the parent may have wanted a safer portfolio invested in government bonds, while the children may want growth-based companies with higher potential return. The decision decomposition process can lead to new recommended asset allocation strategies for the trust. The Decision Decomposition process allows for the portfolio to be restructured to meet the needs of the new market participants. This may also occur for shifts in markets, changes in conditions and changes in beneficiary investment goals. Example Application: Suppose a beneficiary dies and is replaced with two new beneficiaries (children of the beneficiary). These individuals may have different investment needs, so the portfolio may need to be rebalanced.

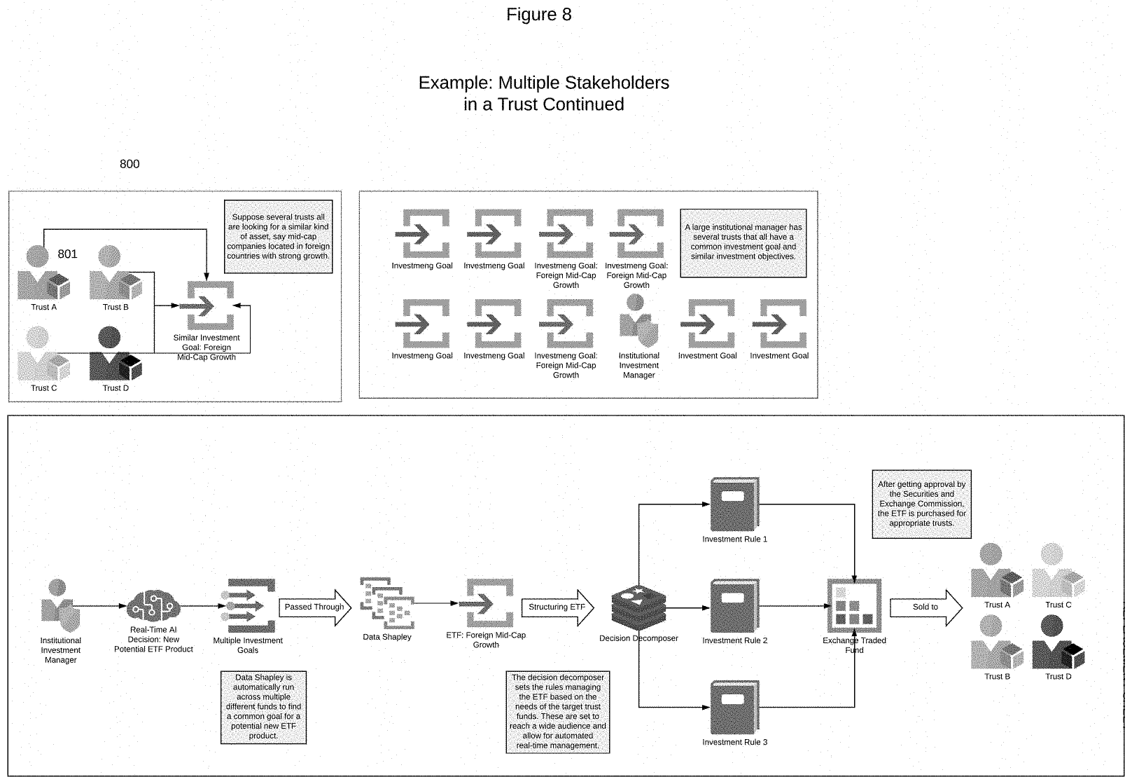

FIG. 8 shows the creation of new exchange traded funds (ETF) 800 based on data from multiple trusts 801. In this example, consider a large institutional investment manager who manages many trusts. In this example, the trust 801 from FIG. 7 is one of several trusts the investment manager is overseeing. Four trusts are shown in this example, although in practice investment managers may be managing the assets of hundreds of trusts. The institutional investment manager uses the proposed invention to notice that several trusts have some key characteristics in common. In particular, many of them are looking for investments in mid-cap foreign companies with strong growth potential. Real-time data analytical and artificial intelligence passes the many investment goals through a Data Shapley process, notices this key characteristic the many trusts have in common, and suggests a new exchange traded fund: a foreign mid-cap ETF. The decision decomposer suggests the way different decision goals and criteria interact for the funds, leading to some suggested decision rules. Using these decision rules together, a new ETF product can be created. This ETF can then be sold to the trusts for which it would be an appropriate investment vehicle. This process allows the trusts to gain access to a low-cost, simple investment vehicle that is easy to manage while the institutional investment manager can launch a new ETF that meets the needs of his or her clients.

An overview of this process can be seen in FIG. 1 and FIG. 2 which show an example of an application of this entire process for a single stakeholder in a clinical trial setting.

As shown in FIG. 1, the process starts in step 100 with identifying the problem to be studied. In some cases, the problem is straightforward, such as determining what compounds to use in clinical trials. In some cases, the problem can be poorly defined, such as improving welfare. Generally, the more compactly defined the problem the easier it will be to analyze.

The next step 120 involves using data analytics and machine learning to analyze the structure of the problem. If there are multiple stakeholders and or if the desire is to use analytical techniques from state-of-the-art approaches in consulting, then one may use decision conferencing to determine the most relevant factors. These techniques are not necessarily mutually exclusive.

One of the key strategies underlying The Shapley score, Data Shapley techniques and the field of statistics in general is the fact that data has value. While Data Shapley attempts to discriminate the value of one observation via another related to its contribution and Shapley looks to score theoretical value as it pertains to each participant, one must naturally ask how we measure contributions. One of the difficulties inherent is that the value or desires of one individual may be different from that of another. For example, a social network platform may value user engagement, a regulatory agency may value the potential increase in lifespan from a new drug, and a company researching a potential new drug may be interested in the potential market value.

In order to aid this process, the data must first be centralized in a centralized computer database, forming the basis of step 130. This step 130 centralizes the available information into a centralized computer database. In many organizations, data is collected in different formats across different data receptacles, forming diverse and often disparate data streams. This step involves determining the most important information collected across an organization and centralizing it in a database for analysis. This often requires careful thought, as the most important information is not always obvious even in organizations with strong data collection practices. For example, ideas on the roll-out of a new tool may benefit from qualitative feedback from users of said tool, which then has to be coded and converted into a usable format with the rest of the data in the database. The step 130 must convert the information into a common readable format to be compiled in a centralized format. This can be difficult for experienced and well-run organizations but can be a challenge at many organizations that do not have a culture of data collection and preservation. Because step 300 may seem straightforward on paper but can often be challenging to effectively implement, especially where the data is stored in different mediums.

In order to proceed from step 130, the data needs to be passed from a database using Data Shapley 131 into an estimated utility function 132. The connection of game theoretic Shapley to utilities is quite straightforward, but Data Shapley connections to utility theory are more nuanced. The difficulty inherent here is that the Data Shapley approach 131 is itself an estimator, which is then connected to an estimated utility function 132. As such, there are two estimators that are layered in a process to estimate a group utility function 132. An untrained analyst attempting to develop such a solution would need expertise in understanding the desired characteristics of each of these estimators and understanding the linkages between these two methods.

An overview of the workings of steps 131 and 132 can be seen in FIGS. 1 and 3.

One of the unique characteristics of this invention is the connection of normal Shapley to Data Shapley. Shapley's game theory basis means it can be used in situations where data is sparse or missing by modeling preferences and beliefs of multiple players based on theoretical fundamentals. Data Shapley extends this to a data-dependent situation where information is available. One of the unique components of this invention is the linkages of Data Shapley and Game Theory Shapley together, using both theoretical information to inform data collection, data collection to revise the theory, and so on in a circular and looping process. This extends both Shapley and Data Shapley for a larger framework that connects both theoretical and empirical results together. These connections form the basis of connecting this database of information to a utility function estimation process.

Steps 131 and 132 involve analyzing the acquired data using Data Shapley methods. This approach uses Data Shapley to summarize the information we have, and then use this to estimate a utility function. Using Data Shapley, we can determine what the most important information is that we are missing in our search for a solution, and then determine the best sources of new information to acquire. This now involves a trade-off: make a decision with the information we have now, or acquire additional data? For example, in a clinical trial we may choose a multi-stage approach of signing up additional patients if the initial trial is inconclusive.

In essence, this process allows the decision maker to understand the results if he or she stopped and made a decision with the available data, and what the expectation would be regarding the improvement if additional data is collected. In our clinical trial example, we may find that surveying additional patients would lead to additional insights on the side effects of the drug on the most at risk patients, which could be vital information in securing Food and Drug Administration (FDA) approval of the drug. For multiple users, a decision conferencing approach can be used for the estimation of the utility function, which also allows for an information search from the Shapley Data approach.

Before a final decision is made, the decision-making process needs to be decomposed, step 140. In step 6, Data Shapley is used to decompose the decision-making process and obtain estimates of the role each factor plays. Machine learning and data analytics are then used to gain insight into the structural issues, leading to an understanding of the nature of the underlying dilemmas faced in the problem.

Decomposing a process shows how the different factors involved in the decision-making process are related and their relative weights. This process involves using traditional data analytics to explore the weights on the different factors and interactions between factors. These interactions refer to the process of considering how two or more factors work together in unison. For example, age and gender may not appear to play a role regarding the efficacy of a drug compound when considered individually, but jointly may play a role. An example of this would be a drug performing generally well across ages and gender, but poorly for adult males near 50 years of age. This process can also be done with more than two variables, for example in a three-variable situation a drug may have lower efficacy for an adult male near 50 years of age with a history of blood clots. Machine learning is often necessary as there can be many variables in a model, and each time an additional term or interaction is included the model becomes more complicated, more difficult to analyze and the inferences become relatively weaker. As such, machine learning methods can look across different models for patterns and trends to determine if certain parameters and interactions should be included or excluded. For example, in genetic testing and analysis there are hundreds of thousands of potential variables to consider. Once genes are interacted, these can quickly snowball into trillions of potential variable combinations. In order to make analysis reasonable, traditional data analytics can be paired with machine learning to learn what kinds of model structures to investigate for a given problem.

The decomposed decision step 140 is used to understand the role each of the factors plays in the utility function decision, showing how one factor may influence another or how one factor may play a dominant role. Before a decision is reached in the decomposed decision step 140, it is necessary to retain the critical information as the final decision is not simply a binary choice but a dynamic strategy paradigm. The decomposed decision step involves the combination of a multiple statistical techniques with the Data Shapley approach. FIG. 4 shows an example of this decomposition process.

The decomposition process 140 of FIG. 4 starts with a selection of which factor should be given a weighted value. In FIG. 4, the factors are shown as 1401, 1402 and 1403. The factor A 1401 represents a selected factor to weight, factor B 1402 represents another selected factor to be weighed and factor C 1403 represents yet another selected factor to be weighed. The number of factors to be weighed are not limited to only three factors as shown in FIG. 4. Each of the selected factors are run through a Data Shapley search process 1411, 1412, 1413 respectively. The Data Shapley search process 1411, 1412, 1413 analyzes any interactions between each of the weighted factors A (1401), B (1402) and C (1403). The output of the Data Shapley search process 1411 of factor A 1401 is the decomposed A role 1421. Likewise, the output of the Data Shapley search process 1412 of factor B 1402 is the decomposed A role 1422. The output of the Data Shapley search process 1413 of factor C 1403 is the decomposed A role 1423. The analysis also compares the decomposed interaction between the A. B and C factors 1431, 1432 and 1433. Artificial intelligence and decision theory analysis is used to analyze the decompositions 1421, 1431, 1432, 1422, 1433 and 1423 to change the process to address any issues to form a new utility process, and if acceptable will be utilized as the new decision-making process 1440. If the configuration is unacceptable, the decision decomposer 1450 is utilized.

Statistically, this decision-making analytics process involves the initial optimization of dominated strategies, and then the formation of a topological estimation of the joint preferences of participants. This characterizes market participant preferences as a multi-dimensional function in a topological space. A topological space is a generalized space that is more generic than a metric space and allows for complex characterizations. The process then involves using a search process in this topological space for optimal solutions for an arbitrary number of possible options. In the case that the number of options is discrete, the process allows for numerical evaluation of an analytical domain rather than an exhaustive search.

One of the difficulties in this decision-making process is that the topological construction is very generic in what it allows for a configuration. This means that the topological utility could be extremely complex and allows for non-linear and convoluted structures. People tend to exhibit complex and difficult to describe preferences, and at times can be inconsistent, such as the previously mentioned non-transitive preferences. Multiple people together forming a group can have very strangely shaped preferences. Combining multiple groups together means that the final representation can be quite complex indeed. Traditional approaches attempt to restrict searches and ignore these inconsistencies, thus simplifying the search process. This means that the solution can be inaccurate, the search process can get lost in bands that do not properly represent an individual's beliefs and no amount of robustness checks will reveal the presence of these errors. Furthermore, the proposed invention finds that the use of artificial intelligence systems combined with generic search algorithms can address this problem by using advanced computing analytics to allow for these searches. As an example, a high-performance computing cluster could run a Markov Chain Monte Carlo algorithm across multiple cores for the investigation of various pockets of the topology, allowing for an investigation of quite complex problems. In order to address these complexities and reach a decision, insight in the proposed invention uses strategies from decision theory, game theory, non-linear time series analysis, and high-performance computing. While these back-end methods may be quite complicated, the end result presented to the user is quite straightforward. FIGS. 5 and 6 show an example of this process for multiple stakeholders in a clinical trial setting.

Using these analytical methods in tandem, a decision process is run to reach a decision, completing step 150 in FIG. 1. This decision may seem to be a simple choice, but it is in fact a strategy developed to dynamically adjust to a complex and changing world. In step 8, this decision adjusts and reacts to new information as it is acquired. For example, if initial results from a drug trial are negative and poor results regarding mortality show up early the study may be aborted at an earlier stage than normal, saving costs and preventing the loss of life on a compound with limited chance of success. This is because the decision process has been decomposed to allow for new predictions to be made as new information arrives. Critically, this also suggests that at times the model may not have sufficient information to make a reliable decision and can flag when more data is required to reliably make a conclusion. This new decision-making process is not a static result, but a dynamic representation of reality that guides users as new information comes in. Data Shapley also allows for an innovative departure from normal decision theory. The structures built in this process are designed to be proactive rather than merely be reactive. Data analytics and real-time data collection can allow for the prediction of possible future trends or issues that may create uncertainty in the models. This problem can take two forms which we shall address. The first is the dynamic prediction of issues that should be monitored to which the model may be sensitive. Data can then continue to be collected on these issues to inform decisions, similar to the way pharmaceutical companies continue to monitor drugs after they are approved and released on the market. This has broad applications. For example, a company manufacturing hurricane supplies could monitor weather conditions and adjust investment decisions based on projected hurricane numbers.

The second form of proactive prediction involves continuing to feed incidental data collected into the model. As new data is collected, this allows for contextualization of information as it arrives. While the first form is aggressively proactive, the second form is more passive. This is because new passive information streams may not seem to suggest major new occurrences, but this can be misleading. Many passive streams aggregated together with an analytical model can lead to insights about larger trends, which could be problematic for an earlier decision. Thus, the previous decision must be updated based on new evidence.

As an example, the aforementioned developments can be used together for the management of a portfolio of assets. Each of these taken together could be used to assess the financial value of new information, of new assets being added to a portfolio, or as a way of evaluating one criterion versus another in portfolio management. For example, portfolio managers often work with clients that are trusts, pension funds, or have multiple beneficiaries. These methods allow for the decomposition of the desires of these multiple actors in a way that allows for the selection of a portfolio to meet their diverse needs. These methods also work for single beneficiaries when evaluating multiple criteria, as the single-user framework is a special case of the multi-user model where the number of users is one. These methods can also be applied to the creation of an exchange traded fund, where the fund has multiple investment goals and objectives. For example, the ETF could try to mimic the S&P 500 ETF while also having exposure to emerging markets and being twice levered. This process would then select assets automatically in real time and create a set of decision rules and guidelines for the ETF, allowing it to evaluate new market information, assess it according to the objectives set for the ETF and then allow for recommendations about which assets to acquire and at what prices.

An example of this process can be seen in FIGS. 7 and 8.

The above description is not intended to limit the meaning of the words used or in the scope of the following claims that define the invention. Rather, it is contemplated that future modifications in structure, function or result will exist that are not substantial changes and that all such insubstantial changes in what is claimed are intended to be covered by the claims. Thus, while preferred embodiments of the present inventions have been illustrated and described, it will be understood that changes and modifications can be made without departing from the claimed invention. In addition, although the term “claimed invention” or “present invention” is sometimes used herein in the singular, it will be understood that there is a plurality of inventions as described and claims.

Various features of the present inventions are set forth in the following claims.

1.-20. (canceled)

21. A computer implemented analytical method for preparing a utility model to develop structural trends comprising the steps of:
preparing a database of a plurality of factors;
identifying factors to organize a set of control factors from the plurality of factors to use in a decision making process;
analyzing the factors in the control set of factors by employing an algorithm which is configured to employ data analytics to identify the structure of the decision making process to create a plurality of factors forming a set of decision factors and to employ machine learning to characterize and rank the factors in the decision making process then converting the factors forming the set of decision factors into a stored quantitative data set wherein the stored quantitative data set ranks the factors in the quantitative data set;
determining whether an additional factor is necessary in the decision-making process by analyzing the factors in the quantitative data set through the application of an algorithm employing Data Sharpley to the quantitative data set wherein the Data Sharpley operates to decompose the factors in the quantitative data set to scour the factors to determine a change in condition based on the factors and generate a set of additional factors based on the change in condition;
generating a utility function consisting of an algorithm to review the additional factors wherein the utility function operates to the determine the strategy options based on the additional factors by providing a weight to the additional factors to generate a utility score, then utilizing artificial intelligence and data analytics to consolidate the utility scores of the additional factors to generate a utility function representation that weighs the additional factors to determine priority of the additional factors and generate a rank ordering of preferences for the additional factors; and
applying the utility function to the factors in the control set of factors to generate a final set of factors to use in the decision-making process.

22. The computer implemented analytical method for preparing a utility model to develop structural trends of claim 1, further comprising the steps of determining a data analysis factor using a Data Shapley process to analyzes relationships between the decision making factors to determine a weight by searching through different factors given a weight until a data analysis weight for the data analysis factor is determined.

23. The computer implemented analytical method for preparing a utility model to develop structural trends of claim 2, further comprising the step of utilizing the data weight and utilizing artificial intelligence and data analytics to consolidate the data weight in the utility function.

24. The computer implemented analytical method for preparing a utility model to develop structural trends of claim 3, further comprising the step utilizing an algorithm to apply data analytics to locate interactions between the control factors and the final set of factors.

25. The computer implemented analytical method for preparing a utility model to develop structural trends of claim 4, further comprising the step of using decision theory on the final set of factors to determine if further analysis is required.

26. The computer implemented analytical method for preparing a utility model to develop structural trends claim 1, further comprising the step of utilizing the data weight and utilizing artificial intelligence and data analytics to consolidate the data weight in the utility function.

27. The computer implemented analytical method for preparing a utility model to develop structural trends of claim 1 wherein the decision-making process involves a trust.

28. The computer implemented analytical method for preparing a utility model to develop structural trends of claim 1 the decision-making process involve a clinical trial.

29. The computer implemented analytical method for preparing a utility model to develop structural trends of claim 1, wherein the factors, control factors and stored quantitative data set is maintained in a central repository.

30. The computer implemented analytical method for preparing a utility model to develop structural trends of claim 1 further including the step of utilizing decision theory in the utility function to review the additional factors.

31. The computer implemented analytical method for preparing a utility model to develop structural trends of claim 1 further including the step of utilizing game theory in the utility function to review the additional factors.

32. The computer implemented analytical method for preparing a utility model to develop structural trends of claim 1 further including the step of utilizing nonlinear time series in the utility function to review the additional factors.

33. The computer implemented analytical method for preparing a utility model to develop structural trends of claim 10 further including the step of utilizing game theory in the utility function to review the additional factors.

34. The computer implemented analytical method for preparing a utility model to develop structural trends of claim 13 further including the step of utilizing nonlinear time series in the utility function to review the additional factors.

35. The computer implemented analytical method for preparing a utility model to develop structural trends of claim 1 further including the step of utilizing a high-performance computing cluster running a Markov Chain Monte Carlo algorithm across multiple cores as part of the utility function to investigate a pockets of a topology in the additional factors.
